(19) United States
(12) Patent Application Publication
(10) Pub. No.: US 2026/0054530 A1
(43) Pub. Date: Feb. 26, 2026

(54) SIMPLIFIED AND COMPACT TIRE INVERTER

(71) Applicant: Lester Quimpo, Iloilo (PH)

(72) Inventor: Lester Quimpo, Iloilo (PH)

(21) Appl. No.: 18/700,635

(22) PCT Filed: Jun. 17, 2022
(86) PCT No.: PCT/PH2022/050009

§ 371 Date: Apr. 11, 2024

Related U.S. Application Data
(60) Provisional application No. 63/273,866, filed on Oct. 29, 2021.

(51) Int. Cl. B60C 25/15; B09B 3/30; B09B 101/80

(52) U.S. Cl. CPC B60C 25/15; B09B 3/30; B09B 2101/80

(57) ABSTRACT

Apparatuses for inverting tires are described. An apparatus for inverting tires can include, a tabletop, a plurality of legs supporting the tabletop, a stretching plate able to slide up and down through bushings along the plurality of legs, and a lifting device between the tabletop and the stretching plate.

### CROSS REFERENCE TO RELATED APPLICATIONS

This application is a U.S. National Phase Entry of International Application No. PCT/PH2022/050009, filed on Jun. 17, 2022, which claims priority from U.S. Provisional Ser. No. 63/273,866 , filed on Oct. 29, 2021, the entire contents of which are hereby incorporated by reference herein.

### FIELD OF INVENTION

Embodiments of the present invention relate in general to tire handling apparatuses. In particular, embodiments of the present invention relate to a simplified and compact apparatuses for inverting tires.

### BACKGROUND

Throwing away used and old tires presents several hazardous environmental impacts. Due to the chemical makeup of tires, its decomposition and incineration can pollute water, air, and soil. As an example, tires can include heavy metals such as lead that can persist in the environment and accumulate over time. Moreover, it also poses fire risk due to its flammability. Fires fueled by tires are difficult to control and extinguish, and its smoke contains toxic chemicals and particulate matter that presents human health consequences. Further, tires that are thrown away instead of recycled could become a breeding ground for mosquitoes and other pests, which then increase the risk for vector-borne diseases. Given the possible health hazards from discarded tires, technology aids the issue by making tires more durable and ideal for repurposing, recycling, and/or upcycling.

Among common uses of old tires include gardening purposes like plant beds and hanging plant containers. The miniature garden requires less water and the black rubber material absorbs heat from the sun which stimulates plant growth. “Container gardening” is a growing trend with twenty-one million households performing such. It is ideal for gardeners with little or no space; also, it helps control pests, overcome soil issues, and adds versatility to gardens large and small.

The end product of the present technology is inverted tires that can be used as planters, animal food and water basins, tables and stools, hampers, compost/storage/garbage bins, fountains, aquariums, pet beds/bathing tubs, and even septic tanks.

### SUMMARY

In some embodiments, an apparatus for inverting tires includes: a tabletop; a plurality of legs supporting the tabletop; a stretching plate able to slide up and down through bushings along the plurality of legs; and a lifting device between the tabletop and the stretching plate.

In some embodiments, an apparatus for inverting tires includes: a tabletop; a plurality of legs supporting the tabletop; a stretching plate able to slide up and down through bushings along the plurality of legs; a lifting device between the tabletop and the stretching plate; and a plurality of chains distributed evenly around a periphery of the stretching plate, wherein each chain of the plurality of chains has a first end attached to the stretching plate and a second end attached to a respective hook of a plurality of hooks.

In some embodiments, an apparatus for inverting tires includes: a detachable tabletop having a circular shape having a diameter that is smaller than an outside diameter of a tire to be inverted; a plurality of legs supporting the tabletop; a stretching plate able to slide up and down through bushings along the plurality of legs; a lifting device between the tabletop and the stretching plate; and a plurality of chains distributed evenly around a periphery of the stretching plate, wherein each chain of the plurality of chains has a first end attached to the stretching plate and a second end attached to a respective hook of a plurality of hooks.

One aspect is to provide a simplified and compact apparatus for inverting tires.

Another aspect is to produce a form of construction for a tire inverter that promotes portability.

Another aspect is to provide a product that is efficient, user-friendly in operation, cost-effective in manufacturing, and has a mass-market appeal.

Another aspect is to provide a solution to the global issue of what to do with the millions of used tires discarded every year that poses environmental and health hazards.

These and other aspects will become apparent upon reading the following detailed description taken in conjunction with the accompanying drawings.

### BRIEF DESCRIPTION OF THE DRAWINGS

An exemplary embodiment of the present invention is illustrated by way of example in the accompanying drawings in which:

FIG. 1 is a perspective view of an apparatus for inverting tires of the present technology, according to some embodiments;

FIG. 2 is a perspective view of the apparatus of FIG. 1 in the preparatory stage of tire inversion, according to some embodiments;

FIG. 3 is a perspective view of the apparatus of FIG. 2 in the intermediate stage of tire inversion, according to some embodiments; and

FIG. 4 is a perspective view of the apparatus of FIG. 3 in the final stage of tire inversion, according to some embodiments.

### DETAILED DESCRIPTION

The embodiments of the present invention relate in general to tire inverting apparatuses. Specifically, the embodiments of the present invention relate to simplified and compact apparatuses for inverting tires which solve the backbreaking manual method of inverting tires.

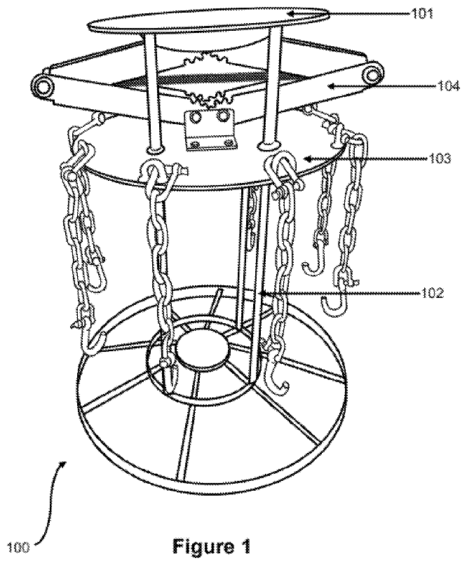

In some embodiments and as shown in FIG. 1, the proposed apparatus for inverting tires (100) has a table-like configuration including a tabletop preferably circular (101); a plurality of legs (102) supporting the tabletop; a stretching plate (103) and a lifting device (104). The diameter of the tabletop (101) should be slightly larger than the rim of the tire to be inverted.

Before the use of the device, one sidewall or rim side of the tire has to be cut out or removed to represent the “opening” in the tire. These openings or cutouts would have to be performed manually to suit the desired ornamental design of the end product (i.e. in the case of a planter this cutout becomes its crown).

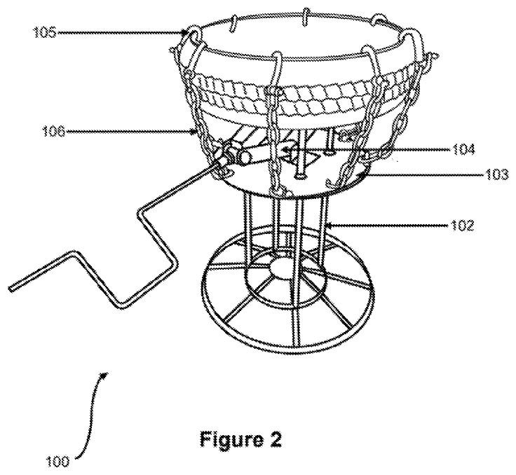

As shown in FIG. 2, in the preparatory stage of tire inversion, the tire is placed in the center in an upright position on the tabletop (101). This means that the “opening” is facing up while the rim side is resting on the tabletop (101). A plurality of hooks (105) and chains (106) are secured evenly spaced along the edge of the tire opening. The other ends of the chains (106) are evenly welded around the periphery of a stretching plate (103) located directly below the tire. This stretching plate (103) slides up and down through bushings along the legs (102) of the tabletop (101) to maintain a consistent parallel position with the tire above it. On the underside of the tabletop (101) a lifting device (104) (i.e. mechanical jack) is inversely mounted to impart motion on the stretching plate (103) below.

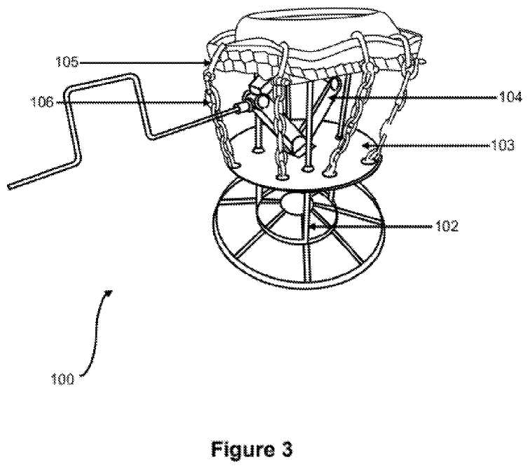

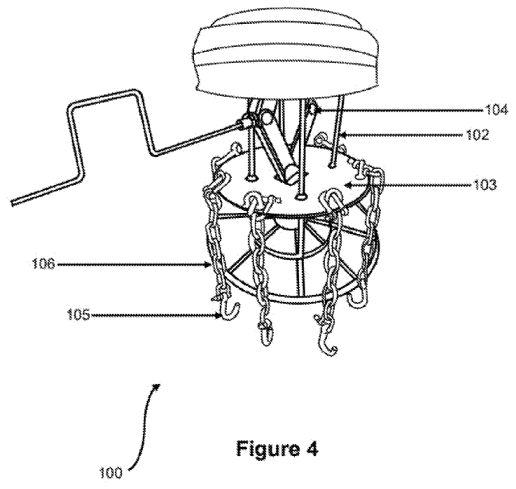

As shown in FIG. 3, in the intermediate stage of tire inversion, when the lifting device (104) is extended/opened the stretching plate (103) slides down. This sliding down action drags the “opening” of the tire to get pass through its rim side thus inverting it inside out completing the process, as shown in FIG. 4.

To repeat the process, remove the inverted tire and raise the stretching plate (103) back up, with all its hooks (105) and chains (106), by operating the lifting device (104) to its close position. Now the machine is ready to be hooked on to the next cutout tire.

In some examples, detachable tabletops (101) of different diameters can be adapted to allow interchangeability of use according to different tire sizes. Also, the lifting device (104) used on this apparatus can be adapted to a power tool like an impact wrench to speed up the process.

The present technology relieves an individual from the backbreaking work of inverting tires inside out by hand. The proposed apparatus performs the tire inversion in a straightforward, speedy, and efficient manner.

As an end product of this technology, inverted tires can be used as planters, animal food and water basins, compost/storage/garbage bins, tables and stools, hampers, fountains, aquariums, pet beds/bathing tubs, and even septic tanks. The inverted tires are more preferable as compared to the traditional materials used to make these end products such as metal, plastic, terracotta, ceramic, concrete, wood, etc. Inverted tires are seamless given that they are without staples or connectors, making them leak-proof. Inverted tires are inexpensive, inexhaustible in supply, and indestructible in nature.

Due to its low-cost fabrication, compact size, abundant supply of raw materials, and ease of operation, this technology poses potential business opportunities for entrepreneurs. As cited above, the end products of inverted tires have many attributes that would make them the perfect material of choice for container garden enthusiasts.

What is claimed is:

1. An apparatus for inverting tires, the apparatus comprising:
a tabletop;
a plurality of legs supporting the tabletop;
a stretching plate able to slide up and down through bushings along the plurality of legs; and
a lifting device between the tabletop and the stretching plate.

2. The apparatus of claim 1, wherein the tabletop is circular in shape.

3. The apparatus of claim 2, wherein a diameter of the tabletop is smaller than an outside diameter of a tire to be inverted.

4. The apparatus of claim 1, further comprising:
a plurality of chains distributed evenly around a periphery of the stretching plate, wherein each chain of the plurality of chains has a first end attached to the stretching plate and a second end attached to a respective hook of a plurality of hooks.

5. The apparatus of claim 1, wherein the tabletop is detachable and replaceable to accommodate different tire sizes.

6. The apparatus of claim 1, wherein the lifting device is a mechanical jack.

7. The apparatus of claim 1, wherein the lifting device is a lead screw.

8. The apparatus of claim 1, wherein the lifting device is adapted to a power tool to speed up a tire inversion process.

9. The apparatus of claim 1, wherein the lifting device is adapted to a gearbox motor to speed up a tire inversion process.

10. An apparatus for inverting tires, the apparatus comprising:
a tabletop;
a plurality of legs supporting the tabletop;
a stretching plate to slide along the plurality of legs;
a lifting device between the tabletop and the stretching plate; and
a plurality of chains distributed evenly around a periphery of the stretching plate, wherein each chain of the plurality of chains has a first end attached to the stretching plate and a second end attached to a respective hook of a plurality of hooks.

11. The apparatus of claim 10, wherein the tabletop is circular in shape.

12. The apparatus of claim 11, wherein a diameter of the tabletop is smaller than an outside diameter of a tire to be inverted.

13. The apparatus of claim 10, wherein the tabletop is detachable and replaceable to accommodate different tire sizes.

14. The apparatus of claim 10, wherein the lifting device is a mechanical jack.

15. The apparatus of claim 10, wherein the lifting device is a lead screw.

16. The apparatus of claim 10, wherein the lifting device is adapted to a power tool to speed up a tire inversion process.

17. The apparatus of claim 10, wherein the lifting device is adapted to a gearbox motor to speed up a tire inversion process.

18. An apparatus comprising:
a detachable tabletop having a circular shape having a diameter that is smaller than an outside diameter of a tire to be inverted;
a plurality of legs supporting the detachable tabletop;
a stretching plate able to slide along the plurality of legs;
a lifting device between the detachable tabletop and the stretching plate; and
a plurality of chains distributed evenly around a periphery of the stretching plate, wherein each chain of the plurality of chains has a first end attached to the stretching plate and a second end attached to a respective hook of a plurality of hooks.

19. The apparatus of claim 10, wherein the lifting device is a lead screw or a mechanical jack.

20. The apparatus of claim 10, wherein the lifting device is adapted to a power tool or a gearbox to speed up a tire inversion process.
